(19) United States
(12) Patent Application Publication
(10) Pub. No.: US 2015/0367428 A1
(43) Pub. Date: Dec. 24, 2015

(54) ROTARY CUTTING TOOL

(71) Applicant: SGS TOOL COMPANY, Munroe Falls, OH (US)

(72) Inventors: Alan Pearce, Wokingham (GB); Jason Hutt, Woking (GB)

(21) Appl. No.: 14/743,127

(22) Filed: Jun. 18, 2015

Related U.S. Application Data
(60) Provisional application No. 62/014,090, filed on Jun. 18, 2014.

(51) Int. Cl. B23C 5/10; B23C 5/28

(52) U.S. Cl. CPC B23C 5/10; B23C 5/28; B23C 2210/0485; B23C 2210/086; B23C 2210/40; B23C 2250/12

(57) ABSTRACT

An end mill rotary cutting tool includes a shaft having an outer surface and a longitudinal axis and including a shank portion and a cutting portion. At least one helical cooling passage is formed in the shaft having a cooing hole in an axial distal end of the shaft. A plurality of helical flutes is formed in the shaft about the longitudinal axis. A plurality of serrated helical cutting edges are formed at an interface with the outer surface and a respective helical flute. A plurality of end cutting edges are located on the axial distal end. The end cutting edges are contiguous with a corresponding one of the serrated helical cutting edges, and form a blend radius at the transition between the end cutting edges and the helical cutting edges. At least three of the end cutting edges meet across the axial distal end to form a gash web.

### CROSS-REFERENCE TO RELATED APPLICATIONS

This application claims priority to and the benefit of U.S. Provisional Patent Application No. 62/014,090 filed Jun. 18, 2014, the contents of which are hereby incorporated in their entirety.

### BACKGROUND

This relates in general to rotary cutting tools. One type of known rotary cutting tool is an end mill. End mills typically consist of one or more flutes including a deep helical groove that runs up the cylindrical outer surface of the milling bit. In operation associated cutting edges may cut a work piece material; together, the flutes and cutting edges—by virtue of rotation of the milling bit—cut away and remove pieces of the work piece in a manner that creates the desired form.

One example of a known rotary cutting tool is the Z-Carb® end mill manufactured under U.S. Pat. No. 4,963,059. The U.S. Pat. No. 4,963,059 disclosed an end mill having a plurality of paired helical flutes forming an even number of helical peripheral cutting edges equally spaced circumferentially in one plane wherein the peripheral cutting edges are formed as a plurality of pairs of diametrically opposite cutting edges having the same helix angle and thereby being symmetrical with respect to the axis of the body.

### SUMMARY

A rotary cutting tool includes a shaft having and outer surface and having a longitudinal axis, a plurality of helical flutes formed in the shaft about the longitudinal axis, and a plurality of helical cutting edges formed at an interface with the outer surface and a respective helical flute about the longitudinal axis.

Various embodiments of the rotary cutting tool disclosed herein will be more fully understood from the following description and drawings.

### BRIEF DESCRIPTION OF THE DRAWINGS

FIG. 1 illustrates a side perspective view of the rotary cutting tool.

FIG. 2 shows a top cross-sectional detail perspective view of the rotary cutting tool of FIG. 1.

FIG. 3 shows a top perspective view of the rotary cutting tool of FIG. 1.

FIG. 4 illustrates a side perspective detail view of an end face of the rotary cutting tool of FIG. 1.

FIG. 5 shows a side detail perspective view of the gash ahead of centre of the rotary cutting tool of FIG. 1.

FIG. 6 illustrates a top view of the rotary cutting tool of FIG. 1.

FIG. 7 illustrates a top detail view of the gash web of the rotary cutting tool of FIG. 1.

FIG. 8 shows a side perspective view of the radius and B-Rad of the rotary cutting tool of FIG. 1.

FIG. 9 illustrates a side perspective view of the dish and gash angles of the rotary cutting tool of FIG. 1.

### DETAILED DESCRIPTION

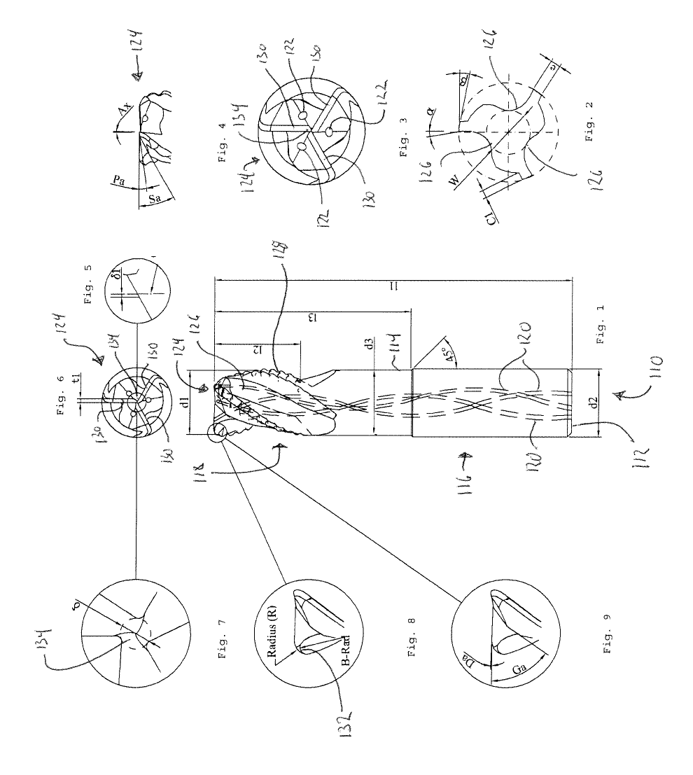

Referring to FIGS. 1-9, there is shown an end mill rotary cutting tool 110.

The End mill 110 includes a shaft 112 having and outer surface 114 and having a longitudinal axis X. The shaft 112 includes a shank portion 116 and cutting portion 118. At least one helical cooling passage 120 (three shown) is formed in the shaft 118. The cooling passages 120 have cooing holes 122 in an axial distal end 124 of the shaft 112.

A plurality of helical flutes 126 are formed in the shaft 112 in the cutting portion 118 about the longitudinal axis X.

A plurality of serrated helical cutting edges 128 formed at an interface with the outer surface 114 and a respective helical flute 126 about the longitudinal axis X.

A plurality of end cutting edges 130 are located on the axial distal end 124 of cutting portion 118 of the shaft 112. The end cutting edges 130 are contiguous with a corresponding one of the plurality of serrated helical cutting edges 128, and forma blend radius 132 at the transition between the end cutting edges 130 and the serrated helical cutting edges 128. At least three of the end cutting edges 130 meet across axial distal end 124 to form a gash web 134.

Table 1 below, with reference to FIGS. 1-9, details geometric data associated with the end mill 110. In Table 1, linear measurements are in millimeters (mm) and angles are in degrees.

TABLE 1
Geometry Data

| Dim | Description | Min | Nom | Max | 1st off |
|---|---|---|---|---|---|
| Dimensional detail | | 44694 Iss2 | | | x |
| d1 | Diameter (top) | 24.950 | 24.970 | 24.990 | |
| Bt | Backtaper | 0 | x | 0.010 | |
| d2 | Diameter of shank | x | 25.000 | x | x |
| l2 | Length of cutting edge | 35.000 | 35.500 | 36.000 | |
| l1 | Overall length | 139.000 | 140.000 | 141.000 | |
| l3 | Length of Shank relief | 80.000 | 80.500 | 81.000 | |
| d3 | Diameter of shank relief | 23.700 | 23.775 | 23.750 | |
| Ha | Helix angle C/C | 37.000 | 38.000 | 39.000 | |
| | Number of flutes | 3 | | | |
| | Coating | NONE | | | x |
| Cross Section Detail | | 44694 Iss2 | | | x |
| β | Primary relief angle | 8.000 | 9.000 | 10.000 | |
| e | Primary angle relief width | 4.850 | 5.000 | 5.150 | |
| W | Core diameter | 11.100 | 11.250 | 11.400 | |
| α | Rake angle | 7.500 | 8.500 | 9.500 | |
| C1 | Height of raised land | x | 1.300 | x | x |
| | Primary relief style | ROUGHING | | | x |
| | Run out of peripheral edge | 0 | x | 0.020 | |
| End face Detail | | 44694 Iss2 | | | x |
| Pa | Primary relief angle | 8.000 | 9.000 | 10.000 | |
| t1 | Primary relief angle width | 1.290 | 1.470 | 1.650 | |
| Sa | Secondary relief angle | 28.000 | 30.000 | 32.000 | |
| Da | Dish angle | 2.000 | 2.500 | 3.000 | |
| Ga | Gash angle | x | 50.000 | x | x |
| Ax | Axial rake angle | x | 6.000 | x | x |
| δ | Gash web thickness | 0.930 | 0.980 | 1.030 | |
| δ1 | Gash ahead of centre | 0.050 | 0.100 | 0.150 | |
| R | Radius | 2.970 | 3.000 | 3.030 | |
| | End face run out | 0 | x | 0.020 | |

While this has been described with reference to certain embodiment(s), it must be understood that various changes may be made and equivalents may be substituted without departing from the scope. In addition, many modifications may be made to adapt a particular situation or material to the teachings without departing from its scope. Therefore, it is intended that this not be limited to the particular embodiment disclosed, but that it will include all embodiments falling within the scope.

What is claimed is:

1. An end mill rotary cutting tool comprising:
a shaft having and outer surface and having a longitudinal axis, the shaft including a shank portion and cutting portion, at least one helical cooling passage formed in the shaft having a cooing hole in an axial distal end of the shaft;
a plurality of helical flutes formed in the shaft in the cutting portion about the longitudinal axis; and
a plurality of serrated helical cutting edges formed at an interface with the outer surface and a respective helical flute about the longitudinal axis; and
a plurality of end cutting edges located on the axial distal end of cutting portion of the shaft, the end cutting edges being contiguous with a corresponding one of the plurality of serrated helical cutting edges, and forming a blend radius at the transition between the end cutting edges and the serrated helical cutting edges, where at least three of the end cutting edges meet across axial distal end to form a gash web.

2. The end mill of claim 1 where the gash web has a thickness between 0.93 mm and 1.03 mm.

3. The end mill of claim 1 where at least one of the serrated helical cutting edges has a rake angle between 7.5 degrees and 9.5 degrees.

4. The end mill of claim 1 where all of the serrated helical cutting edges have a rake angle between 7.5 degrees and 9.5 degrees.

5. The end mill of claim 1 where at least one of the serrated helical cutting edges has a helix angle between 37 degrees and 39 degrees.

6. The end mill of claim 1 where all of the serrated helical cutting edge has a helix angle between 37 degrees and 39 degrees.

7. The end mill of claim 1 where all of the serrated helical cutting edges are generally symmetrical.

8. The end mill of claim 1 where all of the end cutting edges meet to form the gash web.

9. The end mill of claim 1 where there are a three generally symmetrical helical cooling passages.

10. The end mill of claim 1 where the radius of the blend radius is between 2.97 mm and 3.03 mm
